(19) United States
(12) Patent Application Publication
(10) Pub. No.: US 2024/0026130 A1
(43) Pub. Date: Jan. 25, 2024

(54) Bio-Based Polymer Composition Containing Odor Masking Agent

(71) Applicant: Celanese International Corporation, Irving, TX (US)

(72) Inventors: Michael Combs, Shady Spring, WV (US); Rongfu Li, Narrows, VA (US); Ronald Hughes, Narrows, VA (US); Chongwen Huang, Florence, KY (US); Xiaowei Zhang, Union, KY (US); Christopher McGrady, Walton, KY (US)

(21) Appl. No.: 18/356,557

(22) Filed: Jul. 21, 2023

Related U.S. Application Data
(60) Provisional application No. 63/391,035, filed on Jul. 21, 2022.

(51) Int. Cl. C08L 1/12; C08L 67/04; C08K 5/132; C08K 5/521

(52) U.S. Cl. CPC C08L 1/12; C08L 67/04; C08K 5/132; C08K 5/521; C08L 2203/16; C08L 2203/30

(57) ABSTRACT

A polymer composition is disclosed formed from at least one bio-based polymer and at least one odor masking agent. The odor masking agent is designed to control odors by masking the odors during melt processing of the composition without significantly interfering with the optical and/or mechanical characteristics of the composition.

### RELATED APPLICATIONS

The present application is based upon and claims priority to U.S. Provisional Patent Application Ser. No. 63/391,035, having a filing date of Jul. 21, 2022, which is incorporated herein by reference.

### BACKGROUND

Various bio-based polymers have been proposed in the past as a replacement to some petroleum-based polymers or plastics. Examples of bio-based polymers include, for instance, polysaccharide ester polymers and polyhydroxyalkanoate polymers, and the like. Polysaccharide ester polymers include cellulose ester polymers derived from cellulose materials. Cellulose ester polymers are generally considered environmentally-friendly polymers because they are recyclable, degradable and derived from renewable resources, such as wood pulp. Problems have been experienced, however, in melt processing bio-based polymers, such as cellulose acetate polymers. For example, the polymers may not have optimum melt processing characteristics for use in molding processes, such as injection molding. In addition, the bio-based polymers generally do not possess the same mechanical properties as conventionally used petroleum-based polymers. Further, the bio-based polymers can create and release chemical components, such as carboxylic acids, during processing and after the polymer articles are formed. These chemical components can create unwanted and undesirable odors.

In the past, in order to reduce odors, cellulose ester polymers particularly have been combined with inorganic deodorants, such as clay particles, metal phosphates, metal sulfates, charcoal, and the like. The above particles, however, can adversely impact various properties of polymer articles formed from the cellulose ester polymer compositions. For example, polymer articles formed from the polymer composition, for instance, can be discolored.

In view of the above, a need currently exists for biodegradable polymer compositions that exhibit reduced amounts of odors.

### SUMMARY

In general, the present disclosure is directed to a polymer composition containing a bio-based polymer in combination with at least one odor masking agent. The odor masking agent, for instance, is present in the polymer composition in relatively minor amounts and is capable of inhibiting the detection of odors from the composition during melt processing and during use of molded articles made from the polymer composition. The odor masking agent is selected so as to control odors without significantly interfering with the optical or mechanical properties of the polymer composition.

In one embodiment, the present disclosure is directed to a polymer composition containing one or more bio-based polymers. The bio-based polymers can include a polysaccharide ester polymer, such as a cellulose ester polymer, or a bio-based polyester polymer. The composition further optionally contains a plasticizer and an odor masking agent. In accordance with the present disclosure, the odor masking agent comprises a phenolic aldehyde, an alkoxy phenolic compound, a terpene, or a terpene derivative.

Examples of odor masking agents that can be used in accordance with the present disclosure include vanillin, vanillin derivatives, or ethyl vanillin. Other examples of odor masking agents include geraniol, geranyl acetate, guaiacol, eugenol, or mixtures thereof. In general, one or more odor masking agents can be present in the polymer composition in an amount from about 0.001% by weight to about 1% by weight, such as from about 0.001% by weight to about 0.3% by weight.

In one embodiment, the bio-based polymer contained within the polymer composition comprises a cellulose ester polymer. The cellulose ester polymer can be present in the polymer composition in an amount from about 15% to about 85% by weight, such as from about 55% by weight to about 85% by weight. In one aspect, the cellulose ester polymer can have an acetyl value of from about 48% to about 57%, such as from about 50% to less than 53%.

In an alternative embodiment, the bio-based polymer contained within the polymer composition comprises a polyhydroxyalkanoate, such as a polyhydroxybutyrate. The polyhydroxyalkanoate can be present alone or in combination with a cellulose ester polymer. The polyhydroxyalkanoate polymer can be present in the polymer composition in an amount from about 15% to about 98% by weight, such as from about 30% by weight to about 85% by weight.

The plasticizer can optionally be present in the polymer composition generally in an amount from about 8% by weight to about 40% by weight, such as from about 10% by weight to about 35% by weight. In other embodiments, however, little or no plasticizer may be needed. Thus, the plasticizer can also be present in amounts less than about 8% by weight, such as less than about 5% by weight, such as less than about 3% by weight.

Examples of plasticizers that may be used include tris(clorisopropyl) phosphate, tris(2-chloro-1-methylethyl) phosphate, glycerin, monoacetin, triethyl citrate, acetyl triethyl citrate, a phthalate, an adipate, polyethylene glycol, triacetin, diacetin, trimethyl phosphate, triethyl phosphate, tributyl phosphate, triphenyl phosphate, tributyl-o-acetyl citrate, dibutyl tartrate, ethyl o-benzoylbenzoate, n-ethyltoluenesulfonamide, o-cresyl p-toluenesulfonate, aromatic diol, a substituted aromatic diol, an aromatic ether, tripropionin, tribenzoin, glycerin esters, glycerol tribenzoate, glycerol acetate benzoate, polyethylene glycol, a polyethylene glycol ester, a polyethylene glycol diester, di-2-ethylhexyl polyethylene glycol ester, a glycerol ester, diethylene glycol, polypropylene glycol, a polyglycoldiglycidyl ether, dimethyl sulfoxide, N-methyl pyrollidinone, propylene carbonate, a C1-C20 dicarboxylic acid ester, di-butyl maleate, di-octyl maleate, resorcinol monoacetate, catechol, catechol esters, phenols, epoxidized soy bean oil, castor oil, linseed oil, epoxidized linseed oil, difunctional glycidyl ether based on polyethylene glycol, an alkyl lactone, a phospholipid, 2-phenoxyethanol, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, piperidine, piperazine, hexamethylene diamine, triazine, triazole, pyrrole, and mixtures thereof.

In one aspect, the plasticizer selected for use in the polymer composition comprises triacetin, polyethylene glycol, or mixtures thereof.

The polymer composition of the present disclosure can be used to form all different types of articles and products. The polymer composition is well suited for use in various different molding processes, including extrusion, injection molding, blow molding, thermoforming, and the like. For exemplary purposes only, and without limitation, articles that can be made in accordance with the present disclosure include packaging, beverage holders, plastic containers, drinking straws, hot beverage pods, automotive parts, consumer appliance parts, and the like. In one aspect, the polymer composition can first be formed into a film which is then thermoformed into a final product.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of a drinking straw that may be made in accordance with the present disclosure;

FIG. 2 is a cross-sectional view of a beverage holder that may be made in accordance with the present disclosure;

FIG. 3 is a side view of one embodiment of a beverage pod that can be made in accordance with the present disclosure;

FIG. 4 is a cross-sectional view of a drinking bottle that may be made in accordance with the present disclosure;

FIG. 5 is a perspective view of an automotive interior illustrating various articles that may be made in accordance with the present disclosure;

FIG. 6 is a perspective view of cutlery made in accordance with the present disclosure;

FIG. 7 is a perspective view of a lid made in accordance with the present disclosure;

FIG. 8 is a perspective view of a container made in accordance with the present disclosure;

FIG. 9 illustrates one embodiment of a medical apparatus comprising a composition prepared according to the present disclosure;

FIG. 10 illustrates another embodiment of a medical apparatus comprising a composition prepared according to the present disclosure;

FIG. 11 illustrates still another embodiment of a medical apparatus comprising a composition prepared according to the present disclosure; and

FIG. 12 illustrates another embodiment of a medical apparatus comprising a composition prepared according to the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to polymer compositions containing bio-based polymers and molded articles made from the composition. Bio-based polymers are not only biodegradable but can also be sustainable and can be produced from renewable resources. Consequently, such polymers offer various advantages and benefits over many fossil-based polymers. Many bio-based polymers, however, have a tendency to generate steam and odors, such as acidic odors, during compounding and melt processing. Consequently, the present disclosure is directed to incorporating one or more odor masking agents into the polymer composition for controlling odors and emissions. In one aspect, one or more odor masking agents are particularly selected and are loaded into the composition at amounts such that odors are reduced, without compromising other properties of the polymer composition, particularly the optical properties and/or mechanical properties of the polymer composition.

Polymer compositions formulated in accordance with the present disclosure can also have excellent mechanical properties in addition to masking carboxylic acid odor emission odors Further, the polymer composition of the present disclosure can be formulated to be biodegradable and thus environmentally friendly. The polymer composition can be used to form all different types of products using any suitable molding technique, such as extrusion, thermoforming, injection molding, and the like.

As described above, the polymer composition contains a bio-based polymer in combination with one or more odor masking agents. In addition, a plasticizer can optionally be incorporated into the composition in order to vary and change the physical properties of articles formed from the composition. Odor masking agents that are incorporated into the composition generally comprise at least one of a phenolic aldehyde, an alkoxyphenolic compound, a terpene, a terpene derivative, or mixtures thereof.

As used herein, a “bio-based” polymer or plasticizer refers to a polymer, oligomer, or compound produced from at least partially renewable sources, such as produced from plant matter or food waste. For example, a bio-based polymer can be a polymer produced from greater than 30% renewable resources, such as greater than about 40% renewable resources, such as greater than about 50% renewable resources, such as greater than about 60% renewable resources, such as greater than about 70% renewable resources, such as greater than about 80% renewable resources, such as greater than about 90% renewable resources. Bio-based polymers are to be distinguished from polymers derived from fossil resources such as petroleum. Bio-based polymers can be bio-derived meaning that the polymer originates from a biological source or produced via a biological reaction, such as through fermentation or other microorganism process.

In one aspect, the bio-based polymer can comprise a polysaccharide ester polymer, such as a cellulose ester polymer. In another aspect, the bio-based polymer can be a polyester polymer, such as an aliphatic polyester. Particular bio-based polymers that may be incorporated into the polymer composition include polyhydroxyalkanoates, polylactic acid, polycaprolactone, or mixtures thereof. In one embodiment, the polymer composition of the present disclosure can contain a combination of different bio-based polymers. For instance, a cellulose ester polymer can be combined with a bio-based polyester polymer.

In one aspect, a cellulose ester polymer or cellulose acetate polymer is used. Cellulose acetate may be formed by esterifying cellulose after activating the cellulose with acetic acid. The cellulose may be obtained from numerous types of cellulosic material, including but not limited to plant derived biomass, corn stover, sugar cane stalk, bagasse and cane residues, rice and wheat straw, agricultural grasses, hardwood, hardwood pulp, softwood, softwood pulp, cotton linters, switchgrass, bagasse, herbs, recycled paper, waste paper, wood chips, pulp and paper wastes, waste wood, thinned wood, willow, poplar, perennial grasses (e.g., grasses of the Miscanthus family), bacterial cellulose, seed hulls (e.g., soy beans), cornstalk, chaff, and other forms of wood, bamboo, soyhull, bast fibers, such as kenaf, hemp, jute and flax, agricultural residual products, agricultural wastes, excretions of livestock, microbial, algal cellulose, seaweed and all other materials proximately or ultimately derived from plants. Such cellulosic raw materials are preferably processed in pellet, chip, clip, sheet, attritioned fiber, powder form, or other form rendering them suitable for further purification.

Cellulose esters suitable for use in producing the composition of the present disclosure may, in some embodiments, have ester substituents that include, but are not limited to, C₁-C₂₀ aliphatic esters (e.g., acetate, propionate, or butyrate), functional C₁-C₂₀ aliphatic esters (e.g., succinate, glutarate, maleate) aromatic esters (e.g., benzoate or phthalate), substituted aromatic esters, and the like, any derivative thereof, and any combination thereof.

The cellulose acetate used in the composition may be cellulose diacetate or cellulose triacetate. In one embodiment, the cellulose acetate comprises primarily cellulose diacetate. For example, the cellulose acetate can contain less than 1% by weight cellulose triacetate, such as less than about 0.5% by weight cellulose triacetate. Cellulose diacetate can make up greater than 90% by weight of the cellulose acetate, such as greater than about 95% by weight, such as greater than about 98% by weight, such as greater than about 99% by weight of the cellulose acetate.

In general, the cellulose acetate can have a molecular weight of greater than about 10,000 gmol, such as greater than about 20,000 g/mol, such as greater than about 30,000 g/mol, such as greater than about 40,000 g/mol, such as greater than about 50,000 g/mol. The molecular weight of the cellulose acetate is generally less than about 800,000 g/mol, such as less than about 600,000 g/mol, such as less than about 200,000 g/mol, such as less than about 150,000 g/mol, such as less than about 100,000 g/mol, such as less than about 90,000 g/mol, such as less than about 70,000 g/mol, such as less than about 50,000 g/mol. The molecular weights identified above refer to the number average molecular weight. Molecular weight can be determined using gel permeation chromatography using a polystyrene equivalent or standard.

The cellulose ester polymer or cellulose acetate can have an intrinsic viscosity of generally greater than about 0.1 dL/g, such as greater than about 0.5 dL/g, such as greater than about 1 dL/g, such as greater than about 1.2 dL/g, such as greater than about 1.4 dL/g, such as greater than about 1.6 dL/g. The intrinsic viscosity is generally less than about 2 dL/g, such as less than about 1.8 dL/g, such as less than about 1.7 dL/g, such as less than about 1.65 dL/g. Intrinsic viscosity may be measured by forming a solution of 0.20 g/dL cellulose ester in 98/2 wt/wt acetone/water and measuring the flow times of the solution and the solvent at 30° C. in a #25 Cannon-Ubbelohde viscometer. Then, the modified Baker-Philippoff equation may be used to determine intrinsic viscosity (“IV”), which for this solvent system is Equation 1.

$$IV = ( \frac{k}{c} ) ( antilog ( log {n}_{ret} ) / k ) - 1 ) where {n}_{rel} = ( \frac{{t}_{1}}{{t}_{2}} ) , \qquad Equation 1$$

t₁=the average flow time of solution (having cellulose ester) in seconds, t₂=the average flow times of solvent in seconds, k=solvent constant (10 for 98/2 wt/wt acetone/water), and c=concentration (0.200 g/dL).

The cellulose ester polymer contained in the polymer composition can be characterized by its acetyl value or acetylation degree, which is measured in percent. The acetyl value relates to the degree of substitution and provides information regarding the amount of acetic acid that is released from the cellulose ester polymer by saponification. Acetyl value can be measured according to ASTM Test D871-96 (2004). In one embodiment, ASTM Test D871-96 can be modified by substituting acetic acid (60 molecular weight) for acetyl (42 molecular weight) in calculating the acetyl value.

In general, the cellulose ester polymer can have an acetyl value of from about 48% to about 68% (percent combined acetic acid), including all increments of 0.1% therebetween. In one aspect, the acetyl value can be greater than about 54%, such as greater than about 55%, such as greater than about 56%, and generally less than about 65%, such as less than about 63%.

In one particular embodiment, the cellulose ester polymer has a relatively low acetyl value. For instance, the cellulose ester polymer can have an acetyl value of less than about 54%, such as less than about 53% and greater than about 48%, such as greater than about 49%, such as greater than about 50%, such as greater than about 51%.

When a cellulose ester polymer is present as the bio-based polymer, the cellulose ester polymer or cellulose acetate can be present in the polymer composition in an amount greater than about 15% by weight, such as in an amount greater than about 25% by weight, such as in an amount greater than about 35% by weight, such as in an amount greater than about 45% by weight, such as in an amount greater than about 55% by weight. The cellulose acetate is generally present in the polymer composition in an amount less than about 85% by weight, such as in an amount less than about 80% by weight, such as in an amount less than about 75% by weight, such as in an amount less than about 70% by weight, such as in an amount less than about 65% by weight.

Cellulose ester polymer compositions formulated in accordance with the present disclosure can have a melt flow rate of less than about 40 g/10 min, such as less than about 20 g/10 min, such as less than about 15 g/10 min, such as less than about 12 g/10 min, such as less than about 10 g/10 min, such as less than about 8 g/10 min, such as less than about 6 g/10 min, such as less than about 4 g/10 min, such as less than about 2 g/10 min when tested at 210° C. and at a load of 2.16 kg. The melt flow rate can be greater than about 0.5 g/10 min, such as greater than about 1 g/10 min, such as greater than about 2 g/10 min, such as greater than about 5 g/10 min, such as greater than about 10 g/10 min, such as greater than about 12 g/10 min, such as greater than about 15 g/10 min.

In an alternative embodiment, the bio-based polymer can be a bio-based polyester polymer. For instance, the bio-based polyester polymer can be a polyhydroxyalkanoate. The polyhydroxyalkanoate can be a homopolymer or a copolymer. Polyhydroxyalkanoates, also known as “PHAs”, are linear polyesters produced in nature that can be produced by bacterial fermentation of sugar or lipids. More than 100 different monomers can be combined within this family to give materials with extremely different properties. Generally, they can be either thermoplastic or elastomeric materials, with melting-points ranging from 40 to 180° C. The most common type of PHAs is PHB (poly-beta-hydroxybutyrate). Poly(3-hydroxybutyrate) (PHB) is a type of a naturally occurring thermoplastic polymer currently produced microbially inside of the cell wall of a number of wild bacteria species or genetically modified bacteria or yeasts, etc. It is biodegradable and does not present environmental issues post disposal, i.e., articles made from PHB can be composted.

The one or monomers used to produce a PHA can impact the physical properties of the polymer. For example, PHAs can be produced that are crystalline, semi-crystalline, or completely amorphous. For example, poly-4-hydroxybutyrate homopolymer can be completely amorphous with a glass transition temperature of less than about −30° C. and with no noticeable melting point temperature. Polyhydroxybutyrate-valerate copolymers also can be formulated to be semi-crystalline to amorphous having low stiffness characteristics.

Examples of monomer units that can be incorporated in PHAs include 2-hydroxybutyrate, glycolic acid, 3-hydroxybutyrate (hereinafter referred to as 3HB), 3-hydroxypropionate (hereinafter referred to as 3HP), 3-hydroxyvalerate (hereinafter referred to as 3HV), 3-hydroxyhexanoate (hereinafter referred to as 3HH), 3-hydroxyheptanoate (hereinafter referred to as 3HH), 3-hydroxyoctanoate (hereinafter referred to as 3HO), 3-hydroxynonanoate (hereinafter referred to as 3HN), 3-hydroxydecanoate (hereinafter referred to as 3HD), 3-hydroxydodecanoate (hereinafter referred to as 3HDd), 4-hydroxybutyrate (hereinafter referred to as 4HB), 4-hydroxyvalerate (hereinafter referred to as 4HV), 5-hydroxyvalerate (hereinafter referred to as 5HV), and 6-hydroxyhexanoate (hereinafter referred to as 6HH). 3-hydroxyacid monomers incorporated into PHAs are the (D) or (R) 3-hydroxyacid isomer with the exception of 3HP which does not have a chiral center.

In some embodiments, the PHA in the methods described herein is a homopolymer (where all monomer units are the same). Examples of PHA homopolymers include poly 3-hydroxyalkanoates (e.g., poly 3-hydroxypropionate (hereinafter referred to as P3HP)), poly 3-hydroxybutyrate (hereinafter referred to as P3HB) and poly 3-hydroxyvalerate, poly 4-hydroxyalkanoates (e.g., poly 4-hydroxybutyrate (hereinafter referred to as P4HB)), poly 4-hydroxyvalerate (hereinafter referred to as P4HV)) or poly 5-hydroxyalkanoates (e.g., poly 5-hydroxyvalerate (hereinafter referred to as P5HV)).

In certain embodiments, the PHA can be a copolymer (containing two or more different monomer units) in which the different monomers are randomly distributed in the polymer chain. Examples of PHA copolymers include poly 3-hydroxybutyrate-co-3-hydroxypropionate (hereinafter referred to as PHB3HP), poly 3-hydroxybutyrate-co-4-hydroxybutyrate (hereinafter referred to as P3HB4HB), poly 3-hydroxybutyrate-co-4-hydroxyvalerate (hereinafter referred to as PHB4HV), poly 3-hydroxybutyrate-co-3-hydroxyvalerate (hereinafter referred to as PHB3HV), poly 3-hydroxybutyrate-co-3-hydroxyhexanoate (hereinafter referred to as PHB3HH) and poly 3-hydroxybutyrate-co-5-hydroxyvalerate (hereinafter referred to as PHB5HV).

An example of a PHA having 4 different monomer units would be PHB-co-3HH-co-3HO-co-3HD or PHB-co-3-HO-co-3HD-co-3HDd. Typically where the PHB3HX has 3 or more monomer units, the 3HB monomer is at least 70% by weight of the total monomers, such as greater than 90% by weight of the total monomers.

When present, one or more PHAs can be contained in the polymer composition in an amount of about 2% or greater, such as about 10% or greater, such as about 20% or greater, such as about 30% or greater, such as about 40% or greater, such as about 50% or greater, such as about 60% or greater, such as about 70% or greater. One or more PHAs are generally present in the polymer composition in an amount of about 98% or less, such as in an amount of about 85% or less, such as in an amount of about 50% or less, such as in an amount of about 30% or less.

Other bio-based polyester polymers that may be contained in the polymer composition include a polylactic acid or a polycaprolactone.

Polylactic acid may generally be derived from monomer units of any isomer of lactic acid, such as levorotory-lactic acid (“L-lactic acid”), dextrorotatory-lactic acid (“D-lactic acid”), meso-lactic acid, or mixtures thereof. Monomer units may also be formed from anhydrides of any isomer of lactic acid, including L-lactide, D-lactide, meso-lactide, or mixtures thereof. Cyclic dimers of such lactic acids and/or lactides may also be employed. Any known polymerization method, such as polycondensation or ring-opening polymerization, may be used to polymerize lactic acid. A small amount of a chain-extending agent (e.g., a diisocyanate compound, an epoxy compound or an acid anhydride) may also be employed. The polylactic acid may be a homopolymer or a copolymer, such as one that contains monomer units derived from L-lactic acid and monomer units derived from D-lactic acid. Although not required, the content of one of the monomer units derived from L-lactic acid and the monomer units derived from D-lactic acid is preferably about 85 mole % or more, in some embodiments about 90 mole % or more, and in some embodiments, about 95 mole % or more. Multiple polylactic acids, each having a different ratio between the monomer unit derived from L-lactic acid and the monomer unit derived from D-lactic acid, may be blended at an arbitrary percentage.

In one particular embodiment, the polylactic acid has the following general structure:

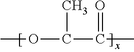

The polylactic acid typically has a number average molecular weight (“Mₙ”) ranging from about 40,000 to about 160,000 grams per mole, in some embodiments from about 50,000 to about 140,000 grams per mole, and in some embodiments, from about 80,000 to about 120,000 grams per mole. Likewise, the polymer also typically has a weight average molecular weight (“M_{w}”) ranging from about 80,000 to about 200,000 grams per mole, in some embodiments from about 100,000 to about 180,000 grams per mole, and in some embodiments, from about 110,000 to about 160,000 grams per mole. The ratio of the weight average molecular weight to the number average molecular weight (“M_{w}/Mₙ”), i.e., the “polydispersity index”, is also relatively low. For example, the polydispersity index typically ranges from about 1.0 to about 3.0, in some embodiments from about 1.1 to about 2.0, and in some embodiments, from about 1.2 to about 1.8. The weight and number average molecular weights may be determined by methods known to those skilled in the art.

When present, polylactic acid can be contained in the polymer composition in an amount of about 1% or greater, such as in an amount of about 10% or greater, such as in an amount of about 20% or greater, and generally in an amount of about 90% or less, such as in an amount of about 70% or less, such as in an amount of about 50% or less, such as in an amount of about 30% or less.

Another bio-based polymer that may be contained in the polymer composition is a polycaprolactone. Polycaprolactones can be made having a number average molecular weight of generally greater than about 5,000, such as greater than about 8,000, and generally less than about 85,000, such as less than about 40,000.

Polycaprolactones can be contained in the polymer composition in an amount of about 2% or greater, such as about 10% or greater, such as about 20% or greater, such as about 30% or greater, such as about 40% or greater, such as about 50% or greater, such as about 60% or greater, such as about 70% or greater. Polycaprolactones are generally present in the polymer composition in an amount of about 90% or less, such as in an amount of about 70% or less, such as in an amount of about 50% or less, such as in an amount of about 30% or less.

The one or more bio-based polymers as described above can be optionally combined with one or more plasticizers. Plasticizers particularly well suited for use in the polymer composition include triacetin, monoacetin, diacetin, and mixtures thereof. In one aspect, the plasticizer incorporated into the polymer composition is a polyalkylene glycol, such as a polyethylene glycol. Other suitable plasticizers include tris(clorisopropyl) phosphate, tris(2-chloro-1-methylethyl) phosphate, triethyl citrate, acetyl triethyl citrate, glycerin, or mixtures thereof.

Other examples of plasticizers include, but are not limited to, trimethyl phosphate, triethyl phosphate, tributyl phosphate, triphenyl phosphate, acetyl tributyl citrate, tributyl-o-acetyl citrate, dibutyl tartrate, ethyl o-benzoylbenzoate, n-ethyltoluenesulfonamide, o-cresyl p-toluenesulfonate, aromatic diol, substituted aromatic diols, aromatic ethers, tripropionin, tribenzoin, glycerin, glycerin esters, glycerol tribenzoate, glycerol acetate benzoate, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrollidinone, propylene carbonate, C₁-C₂₀ dicarboxylic acid esters, dimethyl adipate (and other dialkyl esters), di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkyl lactones (e.g., .gamma.-valerolactone), alkylphosphate esters, aryl phosphate esters, phospholipids, aromas (including some described herein, e.g., eugenol, cinnamyl alcohol, camphor, methoxy hydroxy acetophenone (acetovanillone), vanillin, and ethylvanillin), 2-phenoxyethanol, glycol ethers, glycol esters, glycol ester ethers, polyglycol ethers, polyglycol esters, ethylene glycol ethers, propylene glycol ethers, ethylene glycol esters (e.g., ethylene glycol diacetate), propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, piperidine, piperazine, hexamethylene diamine, triazine, triazole, pyrrole, and the like, any derivative thereof, and any combination thereof.

In one aspect, a carbonate ester may serve as a plasticizer. Exemplary carbonate esters may include, but are not limited to, propylene carbonate, butylene carbonate, diphenyl carbonate, phenyl methyl carbonate, dicresyl carbonate, glycerin carbonate, dimethyl carbonate, diethyl carbonate, ethylene carbonate, propylene carbonate, isopropylphenyl 2-ethylhexyl carbonate, phenyl 2-ethylhexyl carbonate, isopropylphenyl isodecyl carbonate, isopropylphenyl tridecyl carbonate, phenyl tridecyl carbonate, and the like, and any combination thereof.

In still another aspect, the plasticizer can be a polyol benzoate. Exemplary polyol benzoates may include, but are not limited to, glyceryl tribenzoate, propylene glycol dibenzoate, diethylene glycol dibenzoate, dipropylene glycol dibenzoate, triethylene glycol dibenzoate, sucrose benzoate, polyethylene glycol dibenzoate, neopentylglycol dibenzoate, trimethylolpropane tribenzoate, trimethylolethane tribenzoate, pentaerythritol tetrabenzoate, sucrose benzoate (with a degree of substitution of 1-8), and combinations thereof. In some instances, tribenzoates like glyceryl tribenzoate may be preferred. In some instances, polyol benzoates may be solids at 25° C. and a water solubility of less than 0.05 g/100 mL at 25° C.

The plasticizer can also be bio-based. For example, using a bio-based plasticizer can render the polymer composition well suited for contact with food items. Bio-based plasticizers particularly well suited for use in the composition of the present disclosure include an alkyl ketal ester, a non-petroleum hydrocarbon ester, a bio-based polymer or oligomer, such as a polycaprolactone (such as a polycaprolactone diol), having a number average molecular weight of 1000 or less, or mixtures thereof.

In one aspect, the plasticizer is phthalate-free. In fact, the polymer composition can be formulated to be phthalate-free. For instance, phthalates can be present in the polymer composition in an amount of about 0.5% or less, such as in an amount of about 0.1% or less.

In general, one or more plasticizers can be present in the polymer composition in an amount from about 8% to about 40% by weight, such as in an amount from about 12% to about 35% by weight. In one aspect, one or more plasticizers can be present in the polymer composition in an amount of about 19% or less, such as in an amount of about 17% or less, such as in an amount of about 15% or less, such as in an amount of about 13% or less, such as in an amount of about 10% or less. One or more plasticizers are generally present in an amount from about 5% or greater, such as in an amount of about 10% or greater, such as in an amount of about 12% or greater, such as in an amount of about 15% or greater, such as in an amount of about 18% or greater, such as in an amount of about 22% or greater, such as in an amount of about 25% or greater.

In accordance with the present disclosure, the one or more bio-based polymers and one or more plasticizers are combined with one or more odor masking agents to reduce the detection of odors, such as by masking the odors of carboxylic acid emissions. The odor masking agents that can be incorporated into the composition include phenolic aldehydes, alkoxy phenolic compounds, terpenes, terpene derivatives, and the like.

For example, in one aspect, the odor masking agent can comprise vanillin or a compound based on vanillin. For example, in one embodiment, the odor masking agent comprises an alkyl vanillin, such as ethyl vanillin. In other embodiments, various other vanillin derivatives can be used.

In another embodiment, the odor masking agent can comprise a geraniol. Geraniol is a monoterpenoid. Geraniol derivatives can also be used as the odor masking agent, such as geranyl acetate. Other odor masking agents that can be used in accordance with the present disclosure include guaiacol or eugenol. Guaiacol is a monomethoxybenzene that includes a phenol with a methoxy substituent. Eugenol, on the other hand, is an allyl chain-substituted guaiacol. Eugenol is a phenylpropanoid.

In still other embodiments, the odor masking agent can comprise various other phenol and furan derivatives. Further examples of odor masking agents, for instance, include syringol, syringaldehyde, pyrogallol, and mixtures thereof.

Of particular advantage, it was discovered that the odor masking agents of the present disclosure can be very effective at controlling and masking odors. For instance, one or more odor masking agents can be present in the polymer composition generally in an amount less than about 3% by weight, such as in an amount less than about 2.5% by weight, such as in an amount less than about 2% by weight, such as in an amount less than about 1.5% by weight, such as in an amount less than about 1% by weight, such as in an amount less than about 0.8% by weight, such as in an amount less than about 0.6% by weight, such as in an amount less than about 0.4% by weight. In many applications, one or more odor masking agents can be present in the polymer composition in an amount less than about 0.3% by weight, such as in an amount less than about 0.2% by weight, such as in an amount less than about 0.1% by weight, such as in an amount less than about 0.08% by weight, such as in an amount less than about 0.05% by weight. One or more odor masking agents are generally present in the polymer composition in an amount greater than about 0.001% by weight, such as in an amount greater than about 0.007% by weight, such as in an amount greater than about 0.01% by weight.

The polymer composition of the present disclosure may optionally contain various other additives and ingredients. For instance, the polymer composition may contain fillers, antioxidants, pigments, lubricants, softening agents, antibacterial agents, antifungal agents, preservatives, flame retardants, and combinations thereof. Each of the above additives can generally be present in the polymer composition in an amount of about 5% or less, such as in an amount of about 2% or less, and generally in an amount of about 0.1% or greater, such as in an amount of about 0.3% or greater.

Fillers that may be added to the composition can vary depending on the particular application. Fillers can affect the optical properties of articles made from the composition or can be added to provide functionality. Examples of fillers that may be added to the composition include clays such as kaolin clay, metal oxides such as magnesium oxide, metal carbonates such as calcium carbonate, sulfates such as barium sulfate, silica, aluminum oxide, zeolites and the like. In one aspect, for instance, one or more fillers particles may be added to the composition in an amount from about 0.1% by weight to about 30% by weight. For instance, one or more fillers can be incorporated into the composition in an amount from about 1% by weight to about 25% by weight, such as from about 3% by weight to about 12% by weight.

Flame retardants suitable for use in conjunction with a cellulose ester plastic described herein may, in some embodiments, include, but are not limited to, silica, metal oxides, phosphates, catechol phosphates, resorcinol phosphates, borates, inorganic hydrates, aromatic polyhalides, and the like, and any combination thereof.

Antifungal and/or antibacterial agents suitable for use in conjunction with a cellulose ester plastic described herein may, in some embodiments, include, but are not limited to, polyene antifungals (e.g., natamycin, rimocidin, filipin, nystatin, amphotericin B, candicin, and hamycin), imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, caprylic acid, and any combination thereof.

Preservatives suitable for use in conjunction with a cellulose ester plastic described herein may, in some embodiments, include, but are not limited to, benzoates, parabens (e.g., the propyl-4-hydroxybenzoate series), and the like, and any combination thereof.

Pigments and dyes suitable for use in conjunction with a cellulose ester plastic described herein may, in some embodiments, include, but are not limited to, plant dyes, vegetable dyes, titanium dioxide, silicon dioxide, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, CARTASOL® dyes (cationic dyes, available from Clariant Services) in liquid and/or granular form (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid), FASTUSOL® dyes (an auxochrome, available from BASF) (e.g., Yellow 3GL, Fastusol C Blue 74L), and the like, any derivative thereof, and any combination thereof.

In some embodiments, pigments and dyes suitable for use in conjunction with a cellulose ester plastic described herein may be food-grade pigments and dyes. Examples of food-grade pigments and dyes may, in some embodiments, include, but are not limited to, plant dyes, vegetable dyes, titanium dioxide, and the like, and any combination thereof.

Antioxidants may, in some embodiments, mitigate oxidation and/or chemical degradation of a cellulose ester plastic described herein during storage, transportation, and/or implementation. Antioxidants suitable for use in conjunction with a cellulose ester plastic described herein may, in some embodiments, include, but are not limited to, anthocyanin, ascorbic acid, glutathione, lipoic acid, uric acid, resveratrol, flavonoids, carotenes (e.g., beta-carotene), carotenoids, tocopherols (e.g., alpha-tocopherol, beta-tocopherol, gamma-tocopherol, and delta-tocopherol), tocotrienols, tocopherol esters (e.g., tocopherol acetate), ubiquinol, gallic acids, melatonin, secondary aromatic amines, benzofuranones, hindered phenols, polyphenols, hindered amines, organophosphorus compounds, thioesters, benzoates, lactones, hydroxylamines, butylated hydroxytoluene (“BHT”), butylated hydroxyanisole (“BHA”), hydroquinone, and the like, and any combination thereof.

In some embodiments, antioxidants suitable for use in conjunction with a cellulose ester plastic described herein may be food-grade antioxidants. Examples of food-grade antioxidants may, in some embodiments, include, but are not limited to, ascorbic acid, vitamin A, tocopherols, tocopherol esters, beta-carotene, flavonoids, BHT, BHA, hydroquinone, and the like, and any combination thereof.

The polymer composition of the present disclosure can be formed into any suitable polymer article using any technique known in the art. For instance, polymer articles can be formed from the polymer composition through extrusion, injection molding, blow molding, and the like.

Polymer articles that may be made in accordance with the present disclosure include drinking straws, beverage holders, automotive parts, knobs, door handles, consumer appliance parts, and the like.

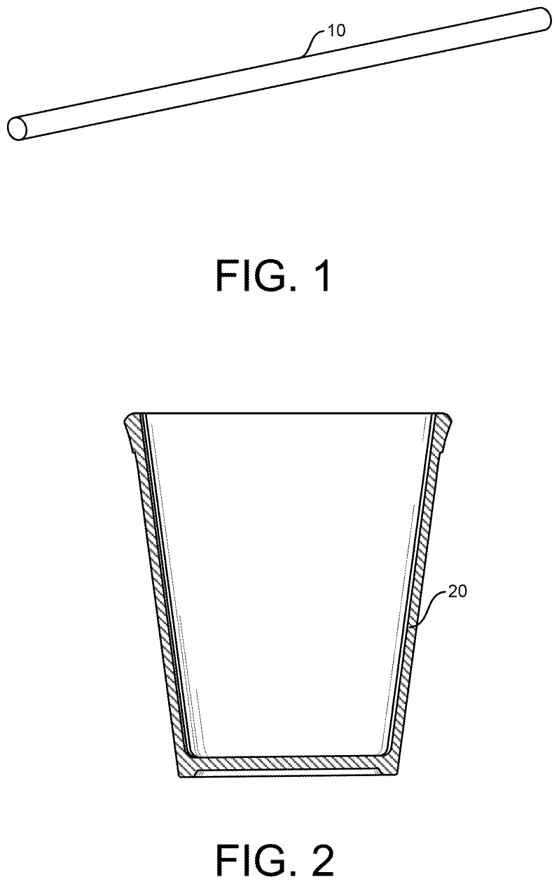

For instance, referring to FIG. 1, a drinking straw 10 is shown that can be made in accordance with the present disclosure. In the past, drinking straws were conventionally made from petroleum-based polymers, such as polypropylene. The cellulose acetate polymer composition of the present disclosure, however, can be formulated so as to match the physical properties of polypropylene. Thus, drinking straws 10 can be produced in accordance with the present disclosure and be completely biodegradable.

Referring to FIG. 2, a cup or beverage holder 20 is shown that can also be made in accordance with the present disclosure. The cup 20 can be made, for instance, using injection molding or through any suitable thermoforming process. As shown in FIG. 7, a lid 22 for the cup 20 can also be made from the polymer composition of the present disclosure. The lid can include a pour spout 24 for dispensing a beverage from the cup 20. In addition to lids for beverage holders, the polymer composition of the present disclosure can be used to make lids for all different types of containers, including food containers, package containers, storage containers and the like.

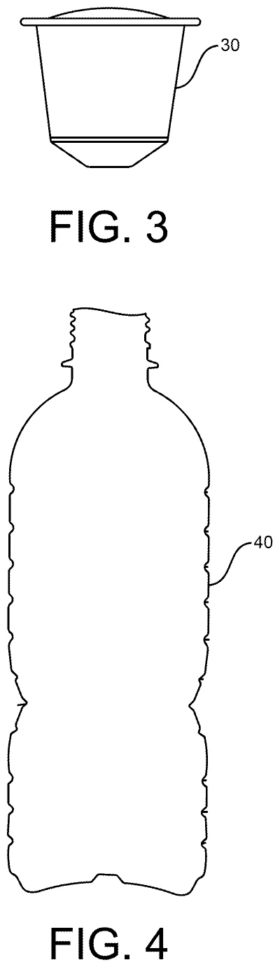

In still another embodiment, the polymer composition can be used to produce a hot beverage pod 30 as shown in FIG. 3. In addition to the beverage pod 30, the polymer composition can also be used to produce a plastic bottle 40 as shown in FIG. 4, which can serve as a water bottle or other sport drink container.

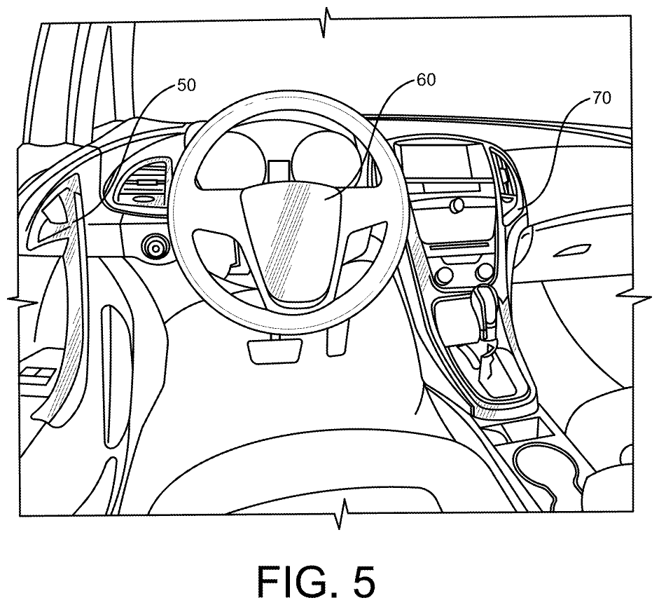

Referring to FIG. 5, an automotive interior is illustrated. The automotive interior includes various automotive parts that may be made in accordance with the present disclosure. The polymer composition, for instance, can be used to produce automotive part 50, which comprises at least a portion of an interior door handle. The polymer composition may also be used to produce a part on the steering column, such as automotive part 60. In general, the polymer composition can be used to mold any suitable decorative trim piece or bezel, such as trim piece 70. In addition, the polymer composition can be used to produce knobs or handles that may be used on the interior of the vehicle.

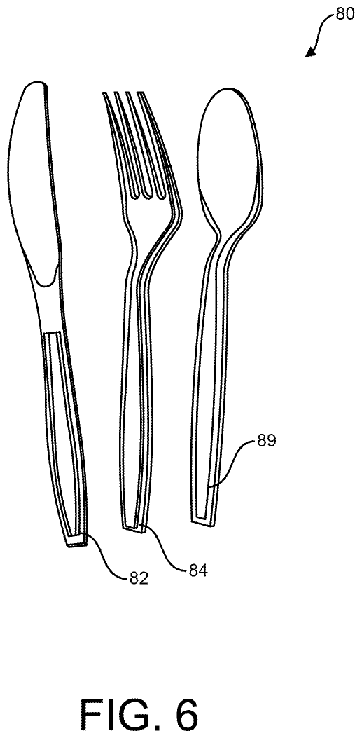

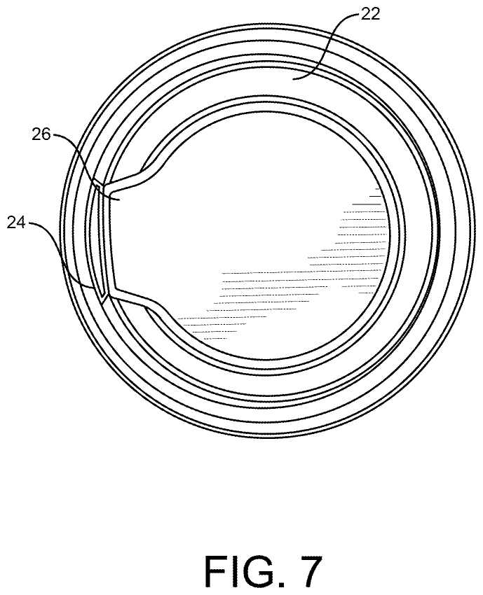

The polymer composition is also well suited to producing cutlery, such as forks, spoons, and knives. For example, referring to FIG. 6, disposable cutlery 80 is shown. The cutlery 80 includes a knife 82, a fork 84, and a spoon 86.

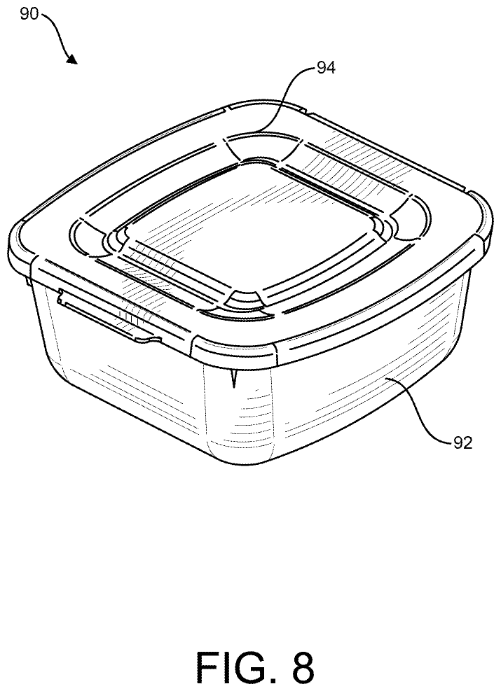

In still another embodiment, the polymer composition can be used to produce a storage container 90 as shown in FIG. 8. The storage container 90 can include a lid 94 that cooperates and engages the rim of a bottom 92. The bottom 92 can define an interior volume for holding items. The container 90 can be used to hold food items or dry goods.

In still other embodiments, the polymer composition can be formulated to produce paper plate liners, eyeglass frames, screwdriver handles, or any other suitable part.

The cellulose ester composition of the present disclosure is also particularly well-suited for use in producing medical devices including all different types of medical instruments. The cellulose ester composition, for instance, is well suited to replacing other polymers used in the past, such as polycarbonate polymers. Not only is the cellulose ester composition of the present disclosure biodegradable, but the composition has a unique “warm touch” feel when handled. Thus, the composition is particularly well suited for constructing housings for medical devices. When held or grasped, for instance, the polymer composition retains heat and makes the device or instrument feel warmer than devices made from other materials in the past. The sensation is particularly soothing and comforting to those in need of medical assistance and can also provide benefits to medical providers. In one aspect, the cellulose ester composition used to produce housings for medical devices includes a cellulose ester polymer combined with a plasticizer (e.g. triacetin) and optionally another bio-based polymer. In addition, the composition can contain one or more coloring agents.

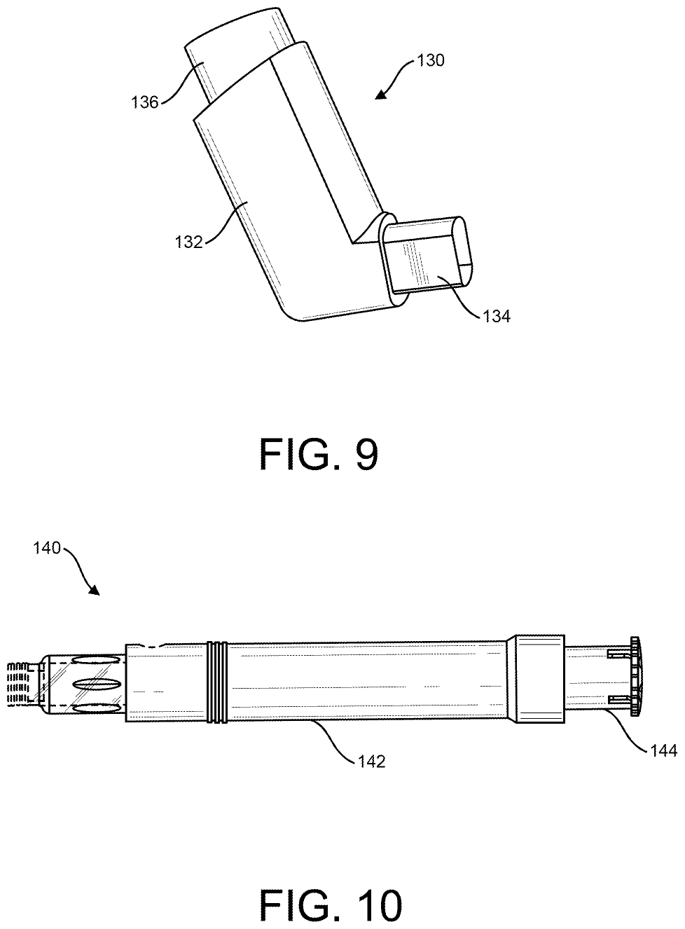

Referring to FIG. 9, for instance, an inhaler 130 is shown that may be made from the cellulose ester polymer composition. The inhaler 130 includes a housing 132 attached to a mouthpiece 134. In operative association with the housing 132 is a plunger 136 for receiving a canister containing a composition to be inhaled. The composition may comprise a spray or a powder.

During use, the inhaler 130 administers metered doses of a medication, such as an asthma medication to a patient. The asthma medication may be suspended or dissolved in a propellant or may be contained in a powder. When a patient actuates the inhaler to breathe in the medication, a valve opens allowing the medication to exit the mouthpiece. In accordance with the present disclosure, the housing 132, the mouthpiece 134 and the plunger 136 can all be made from a polymer composition as described above.

Referring to FIG. 10, another medical product that may be made in accordance with the present disclosure is shown. In FIG. 10, a medical injector 140 is illustrated. The medical injector 140 includes a housing 142 in operative association with a plunger 144. The housing 142 may slide relative to the plunger 144. The medical injector 140 may be spring loaded. The medical injector is for injecting a drug into a patient typically into the thigh or the buttocks. The medical injector can be needleless or may contain a needle. When containing a needle, the needle tip is typically shielded within the housing prior to injection. Needleless injectors, on the other hand, can contain a cylinder of pressurized gas that propels a medication through the skin without the use of a needle. In accordance with the present disclosure, the housing 142 and/or the plunger 144 can be made from a polymer composition as described above.

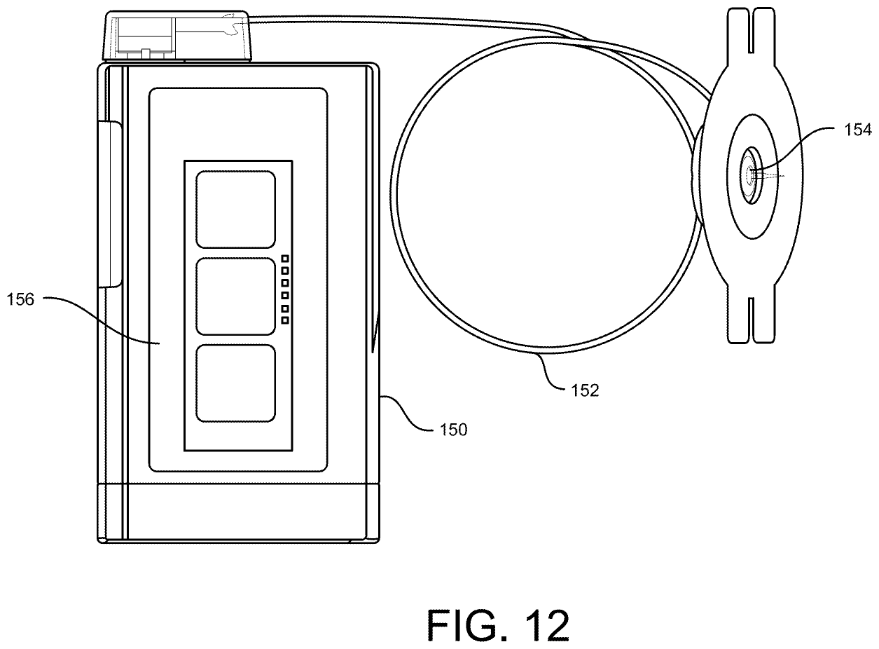

The medical injector 140 as shown in FIG. 10 can be used to inject insulin. Referring to FIG. 12, an insulin pump device 150 is illustrated that can include a housing 156 also made from the polymer composition of the present disclosure. The insulin pump device 150 can include a pump in fluid communication with tubing 152 and a needle 154 for subcutaneously injecting insulin into a patient.

The polymer composition of the present disclosure can also be used in all different types of laparoscopic devices. Laparoscopic surgery refers to surgical procedures that are performed through an existing opening in the body or through one or multiple small incisions. Laparoscopic devices include different types of laparoscopes, needle drivers, trocars, bowel graspers, rhinolaryngoscopes and the like.

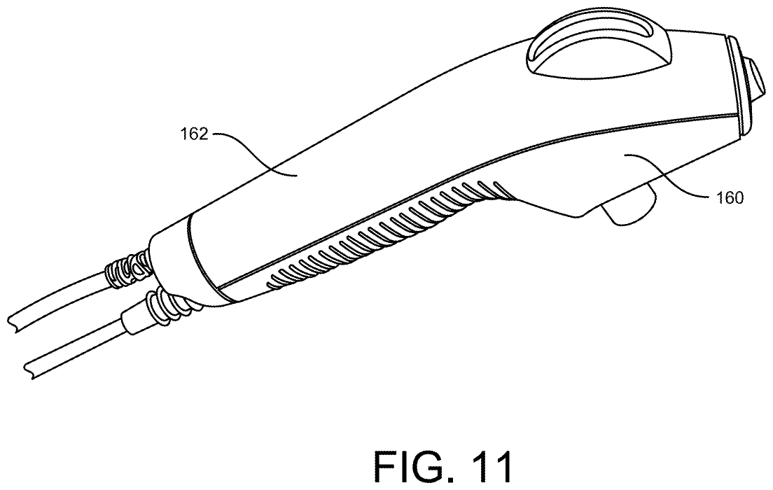

Referring to FIG. 11, for example, a rhinolaryngoscope 160 made in accordance with the present disclosure is shown. The rhinolaryngoscope 160 includes small, flexible plastic tubes with fiberoptics for viewing airways. The rhinolaryngoscope can be attached to a television camera to provide a permanent record of an examination. The rhinolaryngoscope 160 includes a housing 162 made from the polymer composition of the present disclosure. The rhinolaryngoscope 160 is for examining the nose and throat. With a rhinolaryngoscope, a doctor can examine most of the inside of the nose, the eustachian tube openings, the adenoids, the throat, and the vocal cords.

Molded articles can be made from the polymer composition of the present disclosure using any suitable method or technique. For example, fibers and films can be formed through extrusion. Cast films can also be formed. In other embodiments, the molded articles can be formed through injection molding or blow molding.

In one embodiment, the polymer composition can be first formed into a film and then thermoformed into an article.

During thermoforming, the film substrate is heated and then manipulated into a desired three-dimensional shape. The substrate can be formed over a male mold or a female mold. There are two main types of thermoforming typically referred to as vacuum forming or pressure forming. Both types of thermoforming use heat and pressure in order to form a film substrate into its final shape. During vacuum forming, a film substrate is placed over a mold and vacuum is used to manipulate it into a three-dimensional article. During pressure forming, pressure optionally in combination with vacuum forces are used to mold the film substrate into a shape.

The use of thermoforming to produce three-dimensional articles has various advantages. For instance, thermoforming allows for the production of all different types of shapes with fast turnaround times. Modifications to designs can also occur quickly and efficiently. Thermoforming can also be cost effective and can produce articles having an aesthetic appearance.

The temperature and pressure to which the foam substrate is subjected during the thermoforming process can vary depending upon various different factors including the thickness of the foam substrate and the type of product being formed. In general, thermoforming may be conducted at a temperature of from about 75° to about 120°, such as from about 75° to about 100°. Higher temperatures, however, can also be used. As described above, the foam substrate is also subjected to pressure and/or suction forces that press the foam substrate against a mold for conforming the foam substrate to the shape of the mold. Once molded, the three-dimensional article can be trimmed and/or polished as desired.

Films and polymer articles made according to the present disclosure can have excellent optical properties. For example, polymer articles made according to the present disclosure can be measured for haze according to ASTM Test D1003 (2013). Haze can be measured using any acceptable instrument according to the ASTM Test including, for instance, a BYK Gardner Haze-Gard 4725 instrument. Haze can be measured on a test plaque, on a film made according to the present disclosure, or on the final thermoformed article. The test plaque can have any suitable thickness, such as 1 mm, 2 mm, 3 mm, or 4 mm. When any of the above samples are tested, the haze of the sample or article can generally be less than about 40%, such as less than about 30%, such as less than about 20%, such as less than about 15%, such as less than about 10%, such as less than about 8%, such as less than about 5%, such as less than about 3%, such as less than about 2%. In one aspect, the haze can be less than 1%, such as less than about 0.8%, such as less than about 0.5%, such as less than about 0.4%, such as less than about 0.3%, such as less than about 0.2%.

Another way to measure the optical characteristics of the polymer composition is to conduct a gel analysis test. The gel analysis test can be performed on a film made from the polymer composition. The gel analysis test can be conducted by an FSA-100 film surface analyzer commercially available from OCS GmbH of Witten, Germany. The film surface analyzer can include a 4096 pixel CMOS digital camera with a complementary metal oxide semiconductor sensor. The film surface analyzer can have a 50 micron nominal resolution and can include an LED lighting system that enables optimal defect detection in transparent, opaque and colored polymer films. Films can be tested according to the present disclosure at any suitable thickness, such as at a thickness of 25.4 microns. The FSA LID setting is set at 40. The parcel length is set at 102.4 mm and the parcel width is set at 80.00 mm. The parcel area is 8192.00 mm². 367 parcels are inspected and the inspection area is 3.006 m². The inspected length is 37.581 m. The levels are set at 40%-10%-. The other settings include gray value at 169, mean filter size at 50 (50), film speed at 7.01 m/min, exposure time at 0.013 ms, transparency/noise set at 98.88%/2.83%, X resolution set at 50 microns, and Y resolution set at 50 microns. The gel analysis test measures the number of defects per area and the size of the defects.

Films and articles made according to the present disclosure, for instance, can display defects having a size of 300 microns or greater of less than about 5,000 defects/m², such as less than about 3,500 defects/m², such as less than about 2,000 defects/m². Films and articles made according to the present disclosure can display defects having a size of 200 microns or greater in an amount less than about 25,000 defects/m², such as in an amount less than about 20,000 defects/m², such as in an amount of less than about 15,000 defects/m². Films and articles made according to the present disclosure can display defects having a size of 100 microns or greater in an amount less than about 70,000 defects/m², such as in an amount less than about 60,000 defects/m², such as in an amount of less than about 50,000 defects/m².

Films and articles made according to the present disclosure can have a total defect area of less than about 9,000 mm², such as less than about 8,000 mm², such as less than about 7,000 mm², such as less than about 6,000 mm², such as less than about 5,000 mm², such as less than about 4,000 mm², such as less than about 3,000 mm², such as less than about 2,000 mm².

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A polymer composition comprising:
one or more bio-based polymers comprising a cellulose ester polymer, a bio-based polyester polymer, or mixtures thereof;
a plasticizer;
an odor masking agent, the odor masking agent comprising a phenolic aldehyde, an alkoxy phenolic compound, a terpene, or a terpene derivative; and
optionally one or more fillers.

2. A polymer composition as defined in claim 1, wherein the odor masking agent comprises a vanillin derivative.

3. A polymer composition as defined in claim 1, wherein the odor masking agent comprises ethylvanillin.

4. A polymer composition as defined in claim 1, wherein the odor masking agent comprises vanillin.

5. A polymer composition as defined in claim 1, wherein the odor masking agent comprises a geraniol.

6. A polymer composition as defined in claim 1, wherein the odor masking agent comprises geranyl acetate.

7. A polymer composition as defined in claim 1, wherein the odor masking agent comprises guaiacol or eugenol.

8. A polymer composition as defined in claim 1, wherein the odor masking agent is present in the composition in an amount from about 0.001% by weight to about 1% by weight.

9. A polymer composition as defined in claim 1, wherein the bio-based polymer comprises the cellulose ester polymer, and wherein the cellulose ester polymer is present in the polymer composition in an amount from about 15% to about 85% by weight.

10. A polymer composition as defined in claim 1, wherein the plasticizer is present in the polymer composition in an amount from about 8% to about 40% by weight.

11. A polymer composition as defined in claim 9, wherein the cellulose ester polymer has an acetyl value of from about 48% to about 57%.

12. A polymer composition as defined in claim 1, wherein the plasticizer comprises polyethylene glycol, monoacetin, diacetin, triacetin, triethyl citrate, acetyl triethyl citrate, polycaprolactone diol, or mixtures thereof.

13. A polymer composition as defined in claim 9, wherein the cellulose ester polymer is present in the composition in an amount of from about 55% to about 85% by weight and the plasticizer is present in the composition in an amount of from about 10% to about 35% by weight.

14. A polymer composition as defined in claim 9, wherein the cellulose ester polymer consists essentially of cellulose diacetate.

15. A polymer composition as defined in claim 1, wherein the plasticizer comprises tris(clorisopropyl) phosphate, tris(2-chloro-1-methylethyl) phosphate, glycerin, monoacetin, triethyl citrate, acetyl triethyl citrate, a phthalate, an adipate, polyethylene glycol, triacetin, diacetin, trimethyl phosphate, triethyl phosphate, tributyl phosphate, triphenyl phosphate, tributyl-o-acetyl citrate, dibutyl tartrate, ethyl o-benzoylbenzoate, n-ethyltoluenesulfonamide, o-cresyl p-toluenesulfonate, aromatic diol, a substituted aromatic diol, an aromatic ether, tripropionin, tribenzoin, glycerin esters, glycerol tribenzoate, glycerol acetate benzoate, polyethylene glycol, a polyethylene glycol ester, a polyethylene glycol diester, di-2-ethylhexyl polyethylene glycol ester, a glycerol ester, diethylene glycol, polypropylene glycol, a polyglycoldiglycidyl ether, dimethyl sulfoxide, N-methyl pyrollidinone, propylene carbonate, a C1-C20 dicarboxylic acid ester, di-butyl maleate, di-octyl maleate, resorcinol monoacetate, catechol, catechol esters, phenols, epoxidized soy bean oil, castor oil, linseed oil, epoxidized linseed oil, difunctional glycidyl ether based on polyethylene glycol, an alkyl lactone, a phospholipid, 2-phenoxyethanol, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, piperidine, piperazine, hexamethylene diamine, triazine, triazole, pyrrole, and mixtures thereof.

16. A polymer composition as defined in claim 1, wherein the bio-based polymer comprises a polyhydroxyalkanoate.

17. A polymer composition as defined in claim 16, wherein the polyhydroxyalkanoate comprises a polyhydroxybutyrate.

18. A polymer composition as defined in claim 1, further comprising a filler.

19. An article made from the polymer composition as defined in claim 1.

20. An article as defined in claim 19, wherein the article is a beverage holder, a drinking straw, a hot beverage pod, a fork, a knife, a spoon, packaging, a container, a lid, or an interior automotive part.

21. An article as defined in claim 19, wherein the article has been formed through injection molding, thermoforming, or extrusion.

22. An article as defined in claim 19, wherein the article comprises an extruded film.
